(19) United States
(12) Patent Application Publication
(10) Pub. No.: US 2024/0319747 A1
(43) Pub. Date: Sep. 26, 2024

(54) AUTONOMOUS DEPOSITION SYSTEM

(71) Applicant: Micropply Limited, Altrincham, Cheshire (GB)

(72) Inventors: Anthony David George Rhoades, Hale, Cheshire (GB); Samuel Paul Cornish-Evans, Knutsford, Cheshire (GB); Jiri Dohnalek, Warrington, Cheshire (GB); Lewis Cassidy, Sale, Greater Manchester (GB)

(21) Appl. No.: 18/039,065

(22) PCT Filed: Nov. 24, 2021
(86) PCT No.: PCT/GB2021/053049

§ 371 Date: May 26, 2023

(30) Foreign Application Priority Data
Nov. 27, 2020 (GB) 2018749.8

(51) Int. Cl. G05D 1/672; B05C 5/02; B05C 11/10; E01C 23/22; G05D 1/244; G05D 105/00; G05D 107/10; G05D 111/10

(52) U.S. Cl. CPC G05D 1/672; B05C 5/0225; B05C 11/10; E01C 23/22; G05D 1/244; G05D 2105/17; G05D 2107/10; G05D 2111/17

(57) ABSTRACT

A kit is described for enabling an unskilled operator to set up an edge or cloud-connected autonomous distributed deposition robot (ADDR) 10 within minutes of unboxing, autonomously define a deposition zone 120 by following an automated instruction guide to accurately place a smart scanner 210 and other identifiable target objects 220 over a surface, and to use the ADDR and an accompanying Cloud-based automated deposition management software platform to print a design, or otherwise deposit material, accurately over an area such as a sports pitch. The system can also be used to deposit paint, ink, fertiliser, plant seeds or other necessary payload at a particular geographic reference location, indoor or outdoor.

The present invention relates to a system in the form of a kit including a ground-marking Autonomous Distributed Deposition Robot (ADDR) of a type equipped to deposit materials such as an ink and paint, though it may equally deposit sand, seed, fertiliser or other ground treatments onto a ground surface or for injection under pressure into a ground surface; or even discrete items. The kit is designed to include everything needed for an unskilled operator to carry out a deposition process, such as accurately printing a logo on a sports pitch, without knowing any but the barest details of what is required.

The ADDR is equipped with a suite of artificial-intelligence and machine-learning algorithms for optimisation of any ground marking or deposition processes whilst adapting in real time to environmental factors, marking or printing constraints and image or marking accuracy feedback. Each ADDR is therefore a Resource-Rich Smart-Machine (RRSM) and operates within a distributed network which comprises one or many ADDR's that may be working on a ‘mission’ together as a collective, digitally joined and intercommunicating and collaborating ‘fleet’. Alternatively they may work individually in different locations on different missions, all being centrally controlled and co-ordinated.

Autonomous Vehicles may be completely autonomous (i.e. free from human operation and/or supervision) or may require at least partial human operation and/or supervision depending on the application.

Ground marking is typically carried out manually. It requires significant planning, the manufacture of pre-ordered plastic stencils, and large teams of workers to decipher instructions, prepare, lay out and complete a site for marking. Where marking is required such as for logos, safety or hazard signs, the complex make-up of these images mean that difficulties persist to print any image, any size, any colour, directly onto any ground surface without significant cost of time, expense and compromise in image attributes such as resolution.

One approach to automating ground marking is found in US 2005/0055142 A1 in which a remotely controlled turf image marker comprises a ground maintenance vehicle adapted to both mow and store grass as well as carry a marking device that includes a delivery system for applying a marking material to the ground. Dispensing devices for putting down marking materials are provided in the form of boxes requiring mechanisms that need to be driven by a motor, such as an electric, air or other fluid motor. WO 02/28541 (UDW) shows a GPS-controlled vehicle for printing logos over a wide area such as the runoff for a racing track.

However, such systems demand specialist control and have limited resolution. It is desirable to make ground marking or depositing materials on the ground as efficient as printing or marking on paper with high resolution of marking.

According to the present invention, there is provided a kit of parts for autonomously depositing materials on or in the ground within a specific predefined ‘ring-fenced’ control zone using a robot, comprising:
At least one Autonomous Distributed Deposition Robot (ADDR) capable of travelling over the deposition zone, having at least one container for material to be deposited and means for determining its position by reference to reflectors around the zone;
A smart scanner/reflector;
At least two passive reflectors, usually three but more if required, for instance to deposit over larger areas;
An operator interface such as a tablet computer adapted to communicate with the ADDR and the scanner;
A network access point, which can be on board within the ADDR, allowing communication between the ADDR, the scanner and the operator interface; and
Software enabling the operator to be directed to set up the scanner and reflectors, the scanner to survey the position of the reflectors, and the ADDR to receive information on the deposition pattern as it travels. The software can be located in whole or part in the Cloud, in which case the kit will have an Internet access point (Edge).

The ADDR may further include a purge tank, which is simply used as a receptacle to catch purged deposition materials cleaned from the deposition heads/systems/pumps prior to use and at the end of use as a cleaning cycle; a water flush tank for cleaning printing heads; a rechargeable battery with a charging and data-sync station. The kit may also include a autonomous edge/cloud-connected paint refilling station.

The kit can also include an Instruction manual, normally digital; An ADDR protective cover preventing it from damage from vibration, water ingress, moisture, etc.; a protective case for the smart reflector, likewise preventing damage from vibration, water ingress, moisture, etc., passive reflector protective cases similarly, or they can be in the same case.

All of the kit of parts will typically be delivered, and maybe stored, in a case such as a front-opening crate, in an envisaged embodiment having dimensions L 1.4 m×W 1.4 m×H 1.2 m. It could have tethers to restrain the ADDR from unwanted movement during transit. The crate will generally be water-resistant or waterproof. It could be of a more sophisticated design, constituting a reinforced ‘prefab’ with all necessary services, recharging, docking, power, lighting, and other facilities pre-built into the ‘prefab’ structure. When not printing, the ADDR is housed in its proprietary docking station, functioning as both a recharging location and a contact point for receiving future print mission instructions and data synchronization. When the print mission (or missions) are complete, the robot autonomously returns to its start point ready to be docked for re-charging.

For the operator's convenience the crate will have an instruction panel on the front, and other instructional packaging markings on the outer surfaces. The front panel will hinge at its base, opening downward to lie flat or slightly ramped on the ground, so that the ADDR can be driven out, with operating software for further operation of the system once unboxed. To this end the tablet and the ADDR will be at the front of the crate.

In preferred embodiments the tablet will be easily accessible in the crate with instructions on a note onscreen advising the user how to switch on and set up the table (set language, location, etc.). The tablet will display an onscreen set of instructions to guide the user how to (i) untether the ADDR if appropriate, (ii) switch on the ADDR, (iii) use the onscreen ‘virtual joystick’ to control drive the ADDR forward out of the crate, (iv) how to charge before first use. The tablet will guide the user how to unbox and store all parts of the kit. The tablet will guide the user how to dispose of the crate responsibly, unless it is designed to be a permanent prefab as above.

The deposition material container(s) can be tanks for fluid material (liquid or powder/granular), and they may be intelligent (equipped with sensors for indicating the type of material and how much is left). They may be pre-filled with material, such as paint, for deposition. They could be refillable but for ease of operation are adapted to be removed and replaced by a new, full, container as necessary. Alternatively the kit could include an edge/cloud-connected autonomous paint refilling station where the robot would return autonomously to its ‘dock’ to refill itself with the desired deposition materials.

For liquid applications in particular the container can be a flexible bag containing the material for deposition, the flexible bag being provided with an airtight valve outlet sealed to the flexible bag. The use of a ground-marking autonomous robot with flexible bags allows for improvements in the accuracy of the deposition of material, for example in image printing or fertiliser deposition. This allows the optimisation of material deposition, and material use, minimising environmental impact with no compromise to quality of finished product, e.g. a printed logo or a fertilised pitch. Large plastic containers allow material to slosh around inside, creating balance issues for robot printers. They are also bulky, difficult to store once empty and often not recyclable.

The airtight valve outlet may be a tap which releases the contents of the bag when compressed or pressed. The tap may be compressed or pressed by an actuator on the hose or tubing which is then in turn connected to a nozzle or printhead to deposit the material. Because the bag is filled with material on production and the valve is sealed to the flexible bag with an airtight seal, as the contents are released through the valve, the contents of the bag are naturally kept under a vacuum. With a bag under vacuum, there is little or no residual material drip after disconnection, and little “sloshing” of ink.

Furthermore, because the bag is flexible, keeping the contents under a vacuum, the bag shrinks as the contents are released, and no air is stored in the bag. This reduces the weight and thus fuel/energy consumption of the robot in operation. It also means that air is not stored in the bag, which is advantageous for bag contents which may not be stable (either in the long or short term) to air, e.g. paints or fertilisers, which may oxidise. Air may encourage mould or fungal growth inside bags, which is prevented by bring under vacuum.

Flexible bags are also easier to pack down and store once emptied, making re-use or recycling of the bags easier than rigid containers and also providing a weight reduction and reduction in carbon footprint.

However, the bags can be contained in a substantially rigid primary packaging that allows for their protection and ease of transportation. For example, the primary packing may be a lightweight primary packing material, for example recycled material such as cardboard. This protects the contents from impact and puncture, e.g., dropping when installing the bags in the robot. The flexible bags may be removable from the primary packaging before installation in the robot, or, preferably, the bags are installed into the machine whilst still inside the primary packing. The machine may be adapted to hold the flexible bags and/or the primary packing, for example in a frame.

Preferably, when the robot is in use depositing material on the ground, the on-board control system is configured to periodically gather weight data and transmit the data to a remote resource, such as a cloud server, or the operator interface device (tablet or smartphone). A weight monitoring device and data collection allows the system to alert the user that there is not sufficient material for deposition for the instructions given to the robot. For example, prior to operation, the weight monitoring device can check if there is sufficient ink or paint or fertiliser or other deposition material to print a logo, or if there is sufficient fertiliser to cover the area instructed to be fertilised. The user can be informed prior to carrying out the instructions or job, so that the job is not started and then not completed.

The use of weight monitoring also provides a security function, where if the wrong weight of the bag is recorded, then the system, user or supplier may be alerted, possibly via a remote resource, such as a cloud server, or an edge device. This will prevent users from topping up the bags with unauthorised material, which may not work with the system or result in a loss of income for the supplier. For example, the primary packing or flexible bag may have a photodiode or a RFID tag which is linked to a specific weight. When the bag or primary packaging is placed in the robot the sensor may check the photodiode or a RFID tag and the weight monitoring may check the weight of the bag or primary packaging, and if the weight and the photodiode or a RFID tag do not match the credentials of the supplier or owner of the robot, this could mean that some devices have been altered or tampered with and/or the robot may not work or function.

Preferably, the robot and/or the tablet is able to connect to a cloud system. Connection to a cloud system allows the user to achieve functionality anywhere, for example over the air fault diagnostics, real-time print management, vast secure storage and the means to operate robots anywhere in the operator's network. Use of a cloud system allows the collection of data which can aid in machine learning functionality, improve robot diagnostics, data aggregation and secure communication links between the edge, the cloud and all data processing devices as required.

Accordingly, the ground-marking autonomous robot or ADDR, in addition to high accuracy and throughput marking, may provide for robot diagnostics, data aggregation and secure communication links between the edge (interface), the cloud and all data-processing devices as required. The robot is combined with artificial intelligence, machine learning and an end-to-end Cloud SAAS (Software as a Service) or RAAS (Robots as a Service) platform that work together to create ground-printed images approaching the accuracy of a blade of grass, all underpinned with an advanced user interface.

The setup aspect of the present invention will now be described. Once the robot is driven out of the crate, the remaining items, i.e. the reflectors including the “smart reflector” or scanner, are taken out. Together the parts constitute a system for placing or locating objects over a predetermined area, for instance for use as markers for a zone or surface mapping exercise. Such a map may then be used for robot orientation, to allow the Autonomous Distributed Deposition Robot (ADDR) to guide itself to print on turf, e.g. for advertising purposes, or generally to self-navigate to places or locations of interest to perform a duty, such as to deposit a fertiliser, plant seeds, or other necessary payload at a particular geographic reference location. Such uses will usually be outdoors, but indoor applications are envisaged also, such as placement of discrete objects autonomously, or applying factory floor markings, or paint surface coverings over a concrete floor, for example.

Localisation in robotics often requires a map of fixed points of reference in a co-ordinate grid so at any point the robot device can locate itself using these points and calculate where it is on the grid.

Known processes of setting up these fixed points and obtaining their position are inherently complicated, require manual intervention, are time-consuming and require a trained technician skilled in surveying with specialist equipment, such as LiDAR.

The further parts of the kit fulfil the function of automating the identification, and setup, of fixed points for a localisation system to allow rapid installation, preferably across multiple sites, by a user without requiring great skill or training, enabling fast deployment of autonomous vehicles. Such an autonomous vehicle could be a ground printing system that requires fixed reference points with retroreflectors to navigate itself. These fixed points (reflectors) must have known X/Y coordinates and angles set around the print area, and may also need z coordinates in situations where the surface is a complex curve or slope, requiring 3-dimensional mapping.

The smart scanner/reflector typically comprises: a means for generating and directing a beam over the area in various controllable directions; a means for measuring distance to an object in these directions by reflection of the beam from the object; and a processor for identifying a given set of reflections corresponding to a known object, and for calculating the location and, optionally, orientation of the object therefrom.

The means for generating and directing the beam is generally a laser device and it includes the distance-measuring means, e.g. by modulating the beam and measuring time of flight.

The method of setting out or locating the reflectors accurately over a given area comprises the steps of: placing the scanner at a suitable point in relation to the zone, the scanner having a laser whose beam can be directed over the area, and a means for measuring distance; activating the scanner so that it emits a beam in the direction where the first reflector is to be placed; moving the first reflector to a position where it intercepts the beam, if it does not already do so; adjusting the distance of the first reflector from the scanner until the scanner indicates that the distance is correct, and placing the reflector; and repeating the process for the other reflectors as required.

There could be an initial step of using a user interface to define a zone, surface, or area of shape for the placement of the reflectors (such as a rectangle, pentagon or race track)

There can also be a subsequent step, once the objects have been approximately positioned, of surveying them automatically and ascertaining their position and, preferably, orientation precisely, preferably to within 3 mm or even 1 mm. This is done automatically by the scanner.

The scanner preferably comprises a means for emitting a visible beam at various angles in a horizontal plane, a means of measuring distance, and a means for emitting a visual and/or audio signal indicating to an operator whether the distance and/or angle of an object to be placed is as specified.

In particular for surveying applications, the scanner preferably further includes a processor, either integral or remote, for directing the scanner to survey the objects once they have all been placed, to establish their positions precisely and thus to define a map for use by a robot, for instance.

Preferably the means of measuring distance involves modulation of the laser beam itself, in much the same way as an “electronic tape measure”. The audio signal, if used, can be a beep or series of beeps; in particular the time between beeps can decrease as the distance measured becomes closer to the specified distance, signalling to the operator when the object is correctly placed; this is similar to sensor systems used for car parking.

In addition to the scanner, the apparatus further includes a set of passive reflectors to be placed by the operator; for triangulation/trilateration proposes there will be at least two of these, preferably three, though more can be present.

For the survey process the scanner is placed in line of sight of the reflectors, having access to stored data concerning the size and shape of the reflectors; it then moves/pans the beam over the reflectors and measures the distance to several points on each reflector, distinguishing these from neighbouring reflections; the scanner then compares the measured points with the stored data and thus ascertains the location and, preferably, orientation of the or each reflector.

The stored data will generally also include data concerning the approximate location of each reflector. This enables the scanner to direct the beam only, or mainly, within a tolerance of the locations where the reflectors are expected to be according to the stored location data, greatly shortening the survey time.

The reflectors are preferably flat rectangular panels mounted vertically, and the scanner identifies each panel by identifying straight lines of no greater width than the expected angular width of a panel at the measured distance, oriented to face the scanner; usually the panel is not exactly facing the scanner so the observed width is somewhat less and the distances of measured points recede from the scanner. Smoothing and filtering processes can be carried out to distinguish lines of points representing actual panels from spurious reflections.

Once the positions of the reflectors are accurately ascertained by the survey, they can be used for a further subsequent step of guiding the robot by means of the reflectors.

The scanner will usually further include, or have access to, a memory storing data about how near the object is and in roughly which direction, and to indicate accordingly to the processor whether the received signal is likely to correspond to the object sought. Reflections significantly nearer or further are classed as spurious, leaving a line of points representing e.g. a vertically mounted flat panel reflector. The measured distance of points in this line gives an orientation in the horizontal plane, which can then be sorted in a memory to build up a map of the set of objects. The processor and/or the memory are preferably located in the scanner but communication with an external computer/database is possible.

Finally, the user interface, in particular a hand-held device such as a tablet computer, contains at least some of the software, e.g. a program interacting with the scanner to prompt for information and to give instructions for the next step, such as the placement of the reflectors. The tablet is also preferably configured to display options such as the size and shape of the area of interest, and of the design to be printed for a printing application. It communicates with the ADDR, the smart scanner and the Cloud via a local network, located preferably in the ADDR.

### BRIEF DESCRIPTION OF THE DRAWINGS

Embodiments of the invention will now be described by way of example only, with reference to the accompanying drawings, in which:

FIG. 1 is a drawing of a kit embodying the invention, about to be removed from a crate in which it is packed;

FIG. 2 is a schematic diagram of a robot comprising an array of primary packaging comprising bags filled with a ground-marking material;

FIG. 3 is a schematic diagram of primary packaging comprising a flexible ink bag with a hose connected to a nozzle array;

FIG. 4 is a plan view of the ground-marking robot;

FIG. 5 is a plan view of a ground-marking operation in progress, in this embodiment tiled printing of a logo;

FIG. 6 is a schematic diagram of a smart communications module as used in the robot;

FIG. 7 is a schematic diagram of a secure communications network between the robot, the edge, the cloud and a data processing device;

FIG. 8 is a schematic diagram of a data processing device screen in the process of selecting a region for ground marking;

FIG. 9 is a schematic diagram of a wedge insert compatible with both primary packing and the flexible ink bag of the present invention shown in plan view;

FIG. 10 illustrates the kit as set out for use, the reflectors being placed in or around a given area and the robot waiting for the survey to finish;

FIG. 11 schematically shows a scanner in accordance with the invention;

FIG. 12 is an outline flow chart of the setup procedure;

FIG. 13 shows a plan view of an application similar to FIG. 10 but for a rectangular area such as a sports pitch;

FIG. 14 is a view of an initial stage of an embodiment of the method;

FIG. 15 is a graphical representation showing the results of a typical survey stage of the method; and

FIG. 16 illustrates the geometry of the survey process.

The present techniques will be described more fully hereinafter with reference to the accompanying drawings. Like numbers refer to like elements throughout.

### DESCRIPTION OF EMBODIMENTS

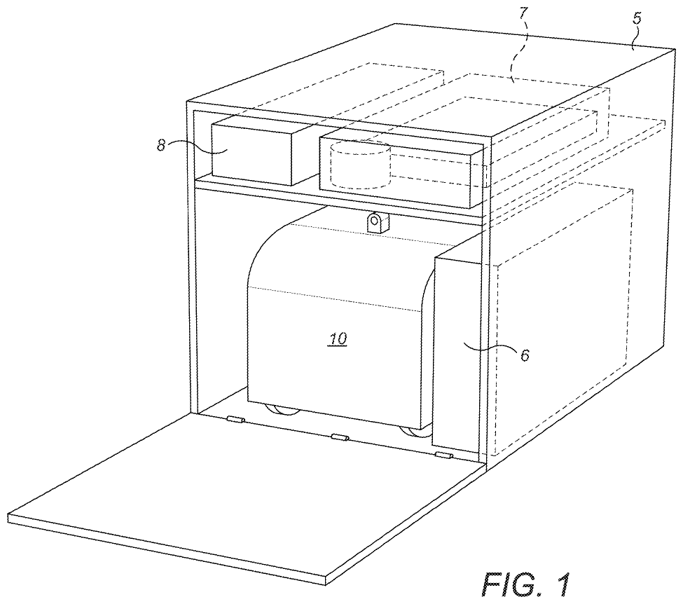

Referring to FIG. 1, a ground marking/deposition kit in accordance with the invention is shown packed in a front-opening crate 5. The crate has just been opened, the front panel having been laid flat on the ground, revealing an ADDR 10 in the lower compartment, two boxes 7, 8, the first containing a user interface (tablet), a smart scanner and reflecting panels to be described, and the second box 8 containing tripods for the smart scanner and the panels. There is also a dock 6, acting as a charging and/or refilling station(s) in the crate.

Typically a mission to be completed (for example, an image to be printed) starts by being converted using bespoke software in the Cloud. In short, the user uploads an image (or images), imports to the print management software, the software asks for user inputs such as size (x,y), resolution (pixel size), surface type (grass, concrete, asphalt, artificial turf). The software then analyses the image and then a print file is then created (in the Cloud). The file is then sent wirelessly to the robot, which communicates it to the scanner, so the scanner knows where the logo is to be placed, and knows how to guide the user to set up the deposition zone with passive/smart reflectors.

If the user wants to set up the ADDR to print more than one image consecutively in the same zone without stopping to restart setup, the user can convert multiple images one after the other, and save them to create multiple separate print files, or one conjoined print file.

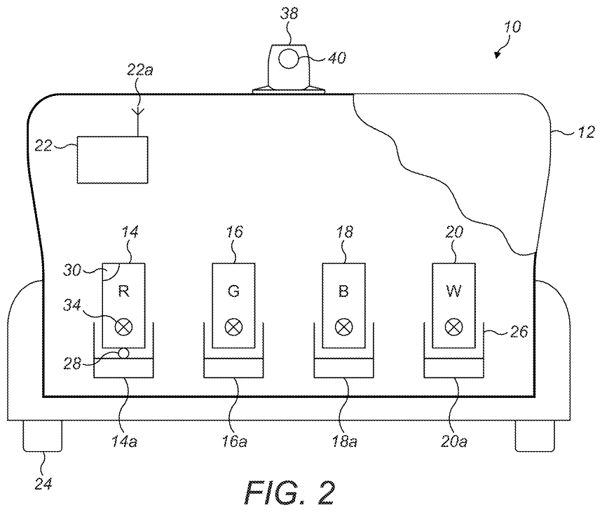

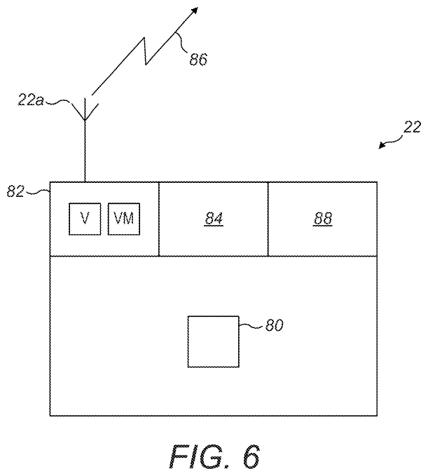

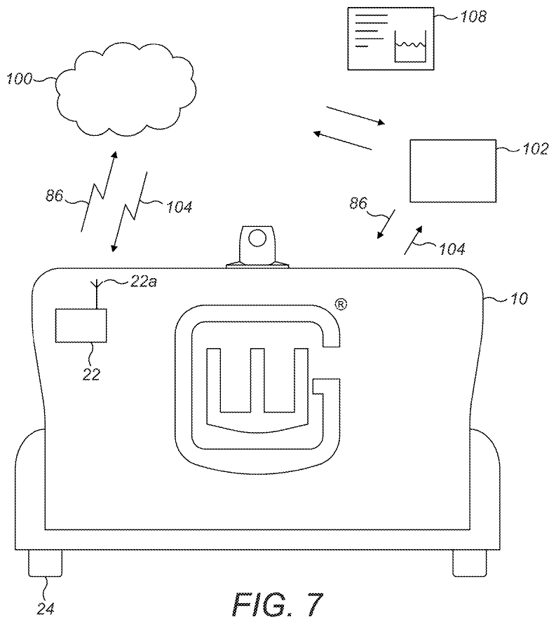

The ADDR 10 will first be described with reference to FIG. 2. The autonomous ground-marking or distributed deposition robot 10 comprises an outer case 12 cut away to reveal an array of primary packaging in the form of cardboard boxes 14, 16, 18 and 20. These hold bags of ink (not shown in FIG. 1), namely comprising a red ink R, a green ink G, a blue ink B and a white ink W. Each primary packaging 14, 16, 18 and 20 is supported on a weight-measuring plate 14a, 16a, 18a and 20a connected to a smart communications module 22 described more fully in FIG. 6, which may also serve as or be connected to an on-board control system (not shown in FIG. 1). The smart communications module 22 comprises a transceiver 22a for communication with remote resources (not shown in FIG. 2—see FIG. 7).

Each weight-measuring plate 14a, 16a, 18a and 20a is an integral part of a frame 26 capable of holding the primary packaging 14, 16, 18, 20 firmly in place and comprises a load sensor 28 for registering the presence of the primary packaging when firmly in place in the frame 26. The load sensor 28 may be a photodiode or a RFID tag that communicates with an ID tag 30 of the primary packaging 14, 16, 18, 20. The ID tag 30 may also comprise a barcode or other smart label, which is used for identification of the primary packaging.

More than one load sensor 28 can be used for load balancing. For example, two, three, four or more load sensors can be positioned as part of or under a platform or frame (which may, for example, be the weight-measuring plate 14a) supporting the ink bag and primary packaging.

The robot 10 has wheels 24 for movement, a position sensor 38 and laser 40. The position sensor 38 can include a Global Positioning Device for navigation, but in preferred embodiments the robot carries out triangulation/trilateration using the reflectors and the laser 40 for positioning, described below. In operation, the robot may be in constant communication with a positioning device and may also reposition itself based on communication from a Global Positioning Device.

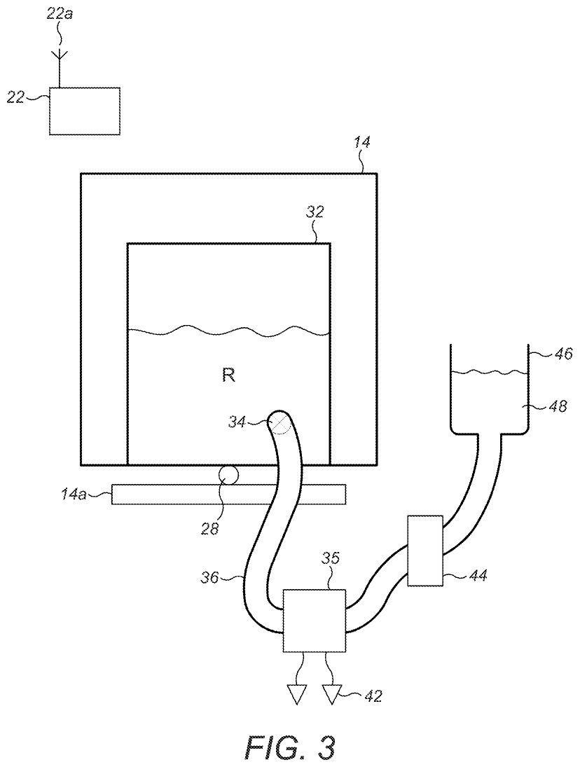

As best seen in FIG. 3, each primary package (14 in this diagram) contains a flexible ink bag 32, which in turn comprises an airtight valve outlet 34 sealed to the flexible ink bag 32 with the appropriate connection part for secure connection to a hose 36. The hose 36 may also be a tube, piping or any suitable means to transport the material for deposition.

The primary packaging 14 comprising the flexible ink bag 32 with the hose 36 is connected to a nozzle array 42 via an actuator pump 35. Here the nozzle array 42 acts as the means to deposit the material for deposition. Any such suitable nozzle, nozzle array or means to deposit the material, depending on the actual material to be deposited, may be used. Each ink bag of the primary packaging 14, 16, 18 and 20 of FIG. 1 will have a hose 36 and valve 34 to connect to the nozzle array 42 via the actuator pump 35. The system may have a single actuator pump 35 for all primary packaging/ink bag/hose (14, 16, 18, 20/32/36), or there may be multiple actuator pumps, i.e. one for each. Each nozzle of the nozzle array 42 may be designated for each primary packaging/ink bag/hose (14, 16, 18, 20/32/36) present, so that each nozzle is for deposition of only the material held in one primary packing/ink bag.

In operation, the nozzle array 42 can deposit materials from each primary packing/ink bag (14, 16, 18, 20/32) individually, or multiple nozzles of an array 42 can operate to blend materials together, e.g. colours of inks or paints, to deposit at the same time. The bags 32 may contain different colours of marking materials, i.e. inks or paints, which may comprise CYM or, if good black is required, CYMK colours. Since the substrate or ground to have these deposited upon is not likely to be white, a white may be required for any print that has white or a paler shade than the colours contained in the bags 32. When depositing ink or paint to print an image, the image may be printed in sweeps to generate small adjacent dots (i.e. each dot comes from a single nozzle of the array 42), which when viewed from above or a suitable distance from afar (e.g. from the stand in a stadium or from a television view) appear to blend into colours, depending on the relative colours of the different inks or colours deposited. Alternatively printing can be continuous.

The flexible ink bag 32 here contains the red ink R suitable for depositing a red colour on a ground, though in general it may contain any material for deposition, for example a marking material or a chemical to deposit on the ground, such as a herbicide, pesticide, insecticide, paint, ink, coloured material, powder, fertilizer, plant growth aid or water, or the like provided that a compatible hose 36 and nozzle arrays 42 are attached.

When printing an image, the flexible ink bags 32 will ideally contain sufficient material to be able to print an entire image without changing during the printing run of the robot. However, if required, an ink bag, or the whole container package 14, can be changed during the deposition cycle.

When a new package 14 or cartridge is to be inserted, the user receives a package containing primary packaging 14 as a lightweight, substantially rigid cardboard box containing therein a flexible bag 32 filled with a ground-marking material, for example a red ink R. The user may register the marking material using the ID tag 30 to match marking materials held in a database by way of communication with module 22. The database may contain a list of verified marking materials authorised for use and may in return grant permission for the robot 10 to accept the material and may, depending in the type of material, make mechanical or software adjustments. For example, the height of a nozzle 42 may be adjusted to spray fertilizer in a different way to an arrangement for high-resolution image printing. The database may also include a revocation list of packaging or materials that are no longer supported, out of date or out of contract, in which case an error message may be displayed to the user.

In some embodiments, the user inserts the complete primary packaging 14 into the frame 26 of the robot 10. Alternatively, if the arrangement allows, then the user may remove the ink bag 32 from the primary packaging 14 and place the ink bag into the frame 26.

The sensor 28 here registers the presence of the primary packaging 14 and further verifies that the correct ink bag 32 is located in the correct frame and may further undertake a verified check of the authenticity of the ink bag 32 using RFID technology or measurement from the weight monitoring plate 14a.

The hose 36 is attached to the valve 34 and, with appropriate setting up of the robot, printing or marking can commence.

During printing or ground marking the weight of the ink bag 32 will decrease as ink is deposited onto the ground. The weight monitoring plate 14a can measure the change in weight and gather data.

The hose 36 is further connected to a manifold 44 connected to a tank 46 containing chemical liquids 48 which serve a variety of purposes. The chemical liquids 48 may be used to flush the hose 36 and nozzles 42, increase or decrease the viscosity of the ink R or ground marking material by suitable mixing and may add effects to standard inks such as luminescent properties or change the chemical make-up of the ink or ground marking material.

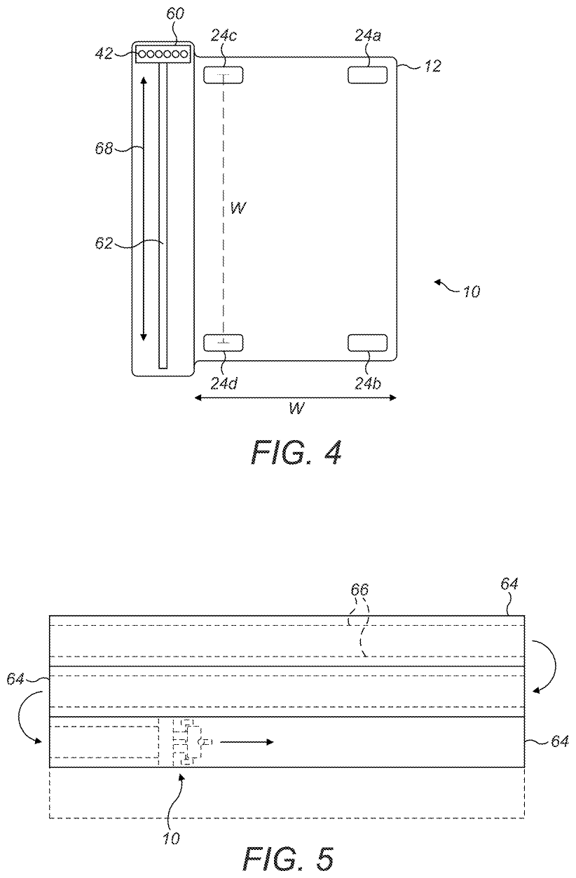

FIG. 4 is a plan view of the robot 10 from underneath. The ground printer robot 10 comprises the case 12 held securely by a chassis supporting the ground wheel arrangement 24, namely four wheels 24a-d in a rectangular arrangement set somewhat inside the outline of the robot. Across the rear side the robot has a print head 60 on a traverse guide 62, the traverse guide 62 being wider than the remainder of the robot, permitting movement of the print head 60 beyond the width W of the ground wheel arrangement 24, along the length of the print width 68. The nozzle array 42 as described above may be attached to the print head 60. The nozzles may be fixed and the print head 60 moveable. The print head 60, via the print guide 62, is here moveable along the print width 68, which defines the area the print head is capable of printing. The print head 60 may also be movable vertically; for example, the printhead 60 can be moved up and down depending on the density of the image to be printed. The printhead can have a means (not shown) to monitor the ground height and adjust the printhead height accordingly, allowing for more accurate image printing or material deposition.

The wheels 24a, 24b, 24c and 24d steer the robot 10 along a path to effect the printing, and this may be under the control of a print file that can be loaded into the on-board control system such as may be contained in the communications module 22. The traverse guide 62 is fixed in relation to the ground wheel arrangement 24, so that it prints one line of an image along the print width 68. The ground wheel arrangement 24 then notches forward, moving the whole printer 10 forward for it to print another line. In another arrangement, not illustrated, the traverse guide 62 can be movable relative to the ground wheel arrangement 24 in the direction of travel, so that an area may be printed while the ground wheel arrangement 24 is stationary, and then the ground wheel arrangement 24 moves forward by the length of the area printed so as to print an adjacent area of image. The print head 60 can, for example, print a line of 10 mm width, then the ground wheel arrangement 24 notch forward by 10 mm. Or an area, say of A4 or A3 paper size can be printed and only then does the robot 10 move forward.

FIG. 5 is a plan view of a ground marking operation in progress, in this embodiment tiled printing of a logo. The robot 10 can print a strip 64 of image wider than the width W of the ground wheel arrangement 24. When an entire strip 64 of image has been printed, the robot turns round to print an adjacent strip. In this way, the ground wheel arrangement 24 does not run over any part of the freshly painted ground, the outer tracks 66 of the ground wheel arrangement 24 being seen in FIG. 5 to be well within the width of the strips 64. The wheel arrangement 24 may have independent drives for front and back wheels, or even for each wheel, to manage torque for optimised positioning accuracy on any surface. The independent drives may be connected to the smart communications module 22 in order to feed back into drive control. The robot 10 is thus able to respond in real time to changing terrain needs. The robot 10 may include an autonomous traction management capability, to safeguard the terrain the robot is interacting with and to reduce skidding and turf damage.

The printhead 60 can, as mentioned, be adjustable in height, whereby to print finer or coarser images or to adapt to ground irregularities. The printhead 60 can use any of a variety of printing techniques, including standard ink jet, spray, and 3D printing techniques involving melting plastic and dropping or shooting it at a ground surface.

Turning to FIG. 6, the smart communications module 22 in the ADDR includes processing circuitry 80 coupled to memory circuitry 82 e.g. volatile memory (V) and/or non-volatile memory (NV), such as such as flash and ROM.

The memory circuitry 82 may store programs to be executed by the processing circuitry 80, as well as data such as user interface resources, time-series data, credentials (e.g. cryptographic keys) and/or identifiers for the remote resource, such as the cloud 100 or the edge (Internet interface, router) 102 (e.g. URL, IP address), shown in FIG. 7. The memory circuitry 80 may also comprise access to machine-learning algorithms stored in libraries to provide for an autonomous robot 10 equipped with artificial intelligence.

The module 22 may also comprise communication circuitry 84 including, for example, near field communicating (NFC), Bluetooth Low Energy (BLE), Wi-Fi, ZigBee or cellular circuitry (e.g. 3G/4G/5G) for communicating with the remote resource(s)/device(s) e.g. over a wired or wireless communication link 86. For example, the module 22 may connect to remote resource(s)/device(s) within a local mesh network over BLE, which in turn may be connected to the internet via an ISP router.

The module 22 may also comprise input/output (I/O) circuitry 88 such as sensing circuitry to sense inputs, e.g. via sensors (not shown), from the surrounding environment and/or to provide an output to a user e.g. using a buzzer or light-emitting diode(s) (not shown). The module 22 may generate operational data based on the sensed inputs, whereby the operational data may be stored in memory 82. The I/O circuitry 88 may also comprise a user interface e.g. buttons (not shown) to allow the user to interact with the module 22.

The processing circuitry 80 may control various processing operations performed by the module 22 e.g. encryption of data, communication, processing of applications stored in the memory circuitry 82. The module 22 may also comprise a display e.g. an organic light-emitting diode (OLED) display (not shown) for communicating messages to the user.

The module 22 may generate operational data based on the sensed inputs. Although the module 22 may comprise large-scale processing devices, often the robot 10 will be constrained to rely on battery power, and so power may need to be managed and prioritised for movement of the robot 10 and actuation of the ground marking. Therefore the module 22 preferably comprises a relatively small-scale data-processing device having limited processing capabilities, which may be configured to perform only a limited set of tasks, such as generating operational data and pushing the operational data to the remote resource 100, 102 as shown in FIG. 7.

For example, the module 22, may, for example, be an embedded device such as an ink registration and ink consumption monitoring device, which generates operational data related to the registration of an input primary packaging 14 comprising an ink bag 32 and the use of the ink R using data generated from the sensor 28 connected to a change in weight detected by the weight monitoring plate 14a.

The module 22 may, for example, include an embedded temperature sensor, which generates operational data based on the temperature of the surrounding environment, and may, for example be generated as a time series and fed, as best seen in FIG. 7, to a remote resource such as the cloud 100, the edge 102, i.e. the tablet, used to control the robot 10 via communications link 86. The cloud 100 or the edge 102 may by return send instructions back to the robot 10 via a communications link 104 for the real-time adjustment of ground marking properties based on the data. In the present example, the cloud 100 and edge 102 may also communicate with each other via a communications link 108 and 110. This could be to update the instructions, send new instructions, initiate or prevent the operation of the robot. The edge 102 may be between the communication between the robot 10 and the cloud 100. The robot laser 40 and position sensor 38 may communicate with the cloud 100 and/or the edge 102 to feedback into the real-time adjustment of ground marking properties based on the data.

The module 22 may comprise an accelerometer which generates data relating to the movement of the robot 10, for example capturing distance moved, or elevation ascended/descended by the robot 10 and fed to the cloud 100 or interface 102 for analysis.

FIG. 7 schematically shows an example of the robot 10 in communication with the cloud 100, the edge/interface 102, which is in effect the user interface or client device, which may be a tablet, smartphone or laptop, and the smart reflector 210, when the present techniques are applied. The tablet 102 is controlled by a user, such as a groundsman located on site responsible for the upkeep of a pitch within a football or rugby stadium. Its screen display is schematically shown as 108.

In the present example, it will be appreciated that the cloud 100 may comprise any suitable data-processing device or embedded system which can be accessed from another platform such as a remote computer, content aggregator or cloud platform which receives data posted by the robot 10. Use of a cloud 100 means that the on-board memory 82 of the robot does not need to store everything, data e.g. machine learning libraries, print instructions and operation instructions, history data can be stored in the cloud 100.

In the present example, the robot 10 is configured to connect with the cloud 100 or the edge 102 to push data thereto, whereby, for the example, the robot 10 may be provided with the connectivity data (e.g. a location identifier such as an address URL) and credential data (e.g. a cryptographic key, certificate, a site secret) of the cloud 100 or the interface 102.

In the present example, on initialisation, e.g. powering on for the first time, the robot 10 undertakes a registration process with the cloud 100 and the edge 102 and pushes identification data and is on standby to receive printing or ground-marking data in return.

In an illustrative example, the user may connect to the remote resource 100, using a browser on the client device 102, whereby, for example, a link in the browser will cause the client device 102 to fetch the data from the remote resource 100, which in the present example is a web-application 108.

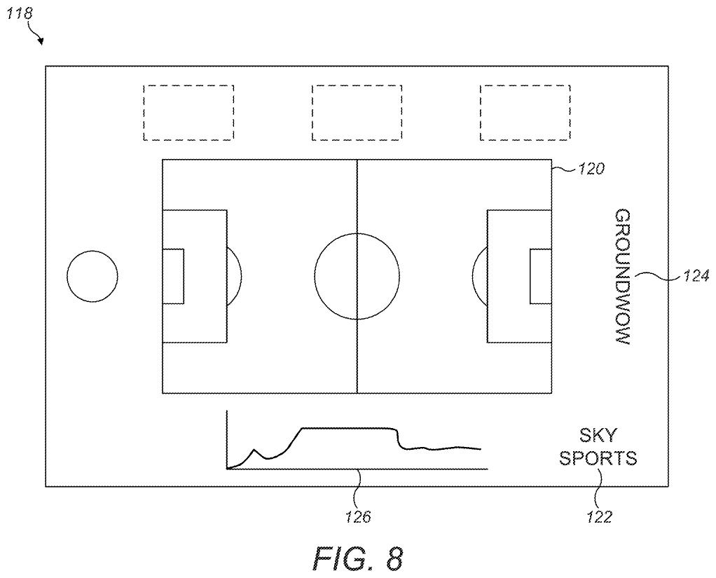

The web application 108 will start in the browser on the client device 102 and cause the client device 102 to fetch data from the remote resource 100, 102. The web application will process the fetched data to provide a user interface to the user on the client device 102, where the user interface presents the data in a human-friendly form such as may be shown in FIG. 8. FIG. 8 is a schematic diagram of a data-processing device screen 118 in the process of, for example, selecting a region for ground marking or analysing data. FIG. 8 shows a football field 120, various printed logos 122, 124 and a graph 126.

For example, the data processing screen 118 may comprise banners, logos, multimedia, animations, interactive features, graphs and/or whereby the user interface is updated in real-time as further data (e.g. further operational data) is fetched from the remote resource 100, 102 as it becomes available after being pushed from the robot 10.

In some embodiments, the client device 102 may download an application (e.g. an IoS application) from the remote resource 100, 102, which was pushed to the remote resource 100, 102 from the robot 10, whereby the application is executed on the client device 102 to control fetching and processing of data.

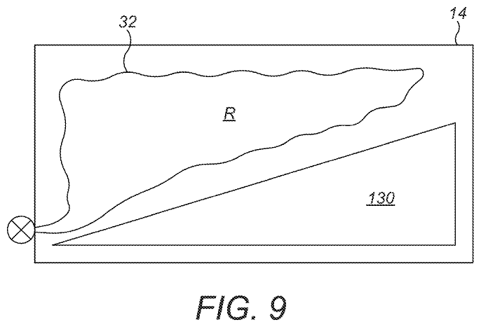

A further feature of the robot is shown in FIG. 9. To aid the efficient dispensing of ground marking material from primary packaging 14, holding for example red ink R, a wedge 130 is placed within the primary packaging 14 and support the flexible bag such that the wedge is tapered towards the outlet of the flexible bag. In other words, the flexible bag sits upon the wedge 130 and the outlet of the flexible bag is closest to the thinnest end of the wedge. Wedges can also be provided in the corners of the primary packaging 14, two corners for example on either side of the outlet or along the base of the primary packaging 14. The wedge 130 aids the dispensing of the ground marking material from the ink bag by providing a funnel effect to the contents of the bag.

The robots, systems and methods described herein can be adapted for use with different types of surface of substrate, depending on the purpose and surface for it to be used with.

The robots, systems and methods described herein can be used to deposit material on multiple different substrates, surfaces, or the ground. For example, these could be, grass, turf, AstroTurf, artificial turf, synthetic turf, plastic turf, concrete, polished concrete, tarmac or tarmacadam ground surfaces, dirt, gravel, wood chip, carpeting, rubber, roads, asphalt, brick, sand, beaches, mud, clay wood, decking, tiling, stone, rock and rock formations of varying types of rock or stone, snow, ice, ice rinks, artificial snow, polymer surfaces such as polyurethane, plastic, glass and leather.

The robots, systems, and methods described herein can be adapted for use with different surfaces, such as sports (e.g. football, cricket, racing, rugby, hockey, ice hockey, skiing, shooting) pitches, ski slopes, dry ski slopes, race courses, gymnasia, indoor sports venues and running tracks.

The other elements of the kit, relating to the navigation of the robot, will now be described.

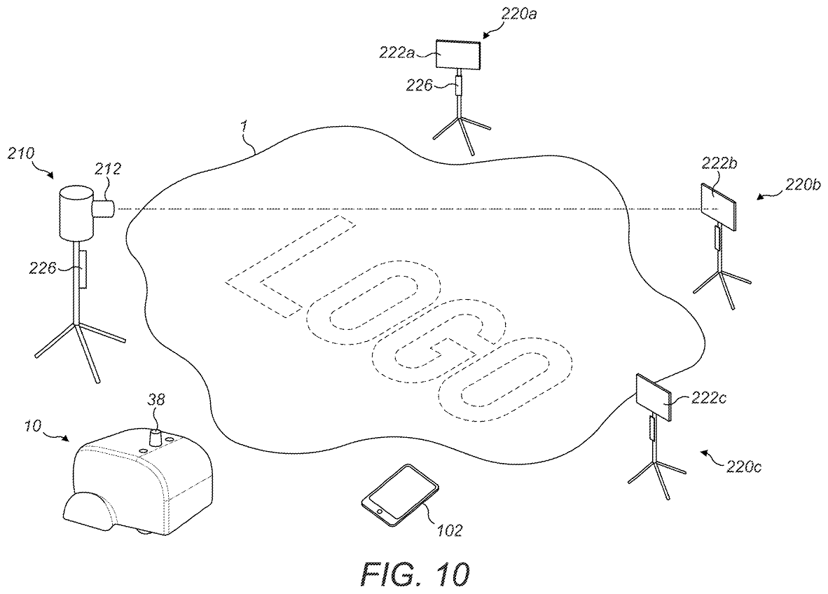

FIG. 10 shows an area 120 (such as the football pitch shown on the display in FIG. 8), in or around which various objects, here reflectors mounted on tripods, 220, are to be placed using the intelligent scanner or survey device 210. Each object 220 has a reflector 222, or a part 222 that reflects, capable of giving a return signal to the scanner. It also has a retro-reflector 226 in the form of a vertical strip about 60 cm (30-100 cm) tall and 10 cm (5-25 cm) wide, for use in the subsequent navigation process, and the scanner also has one such reflector, in this embodiment.

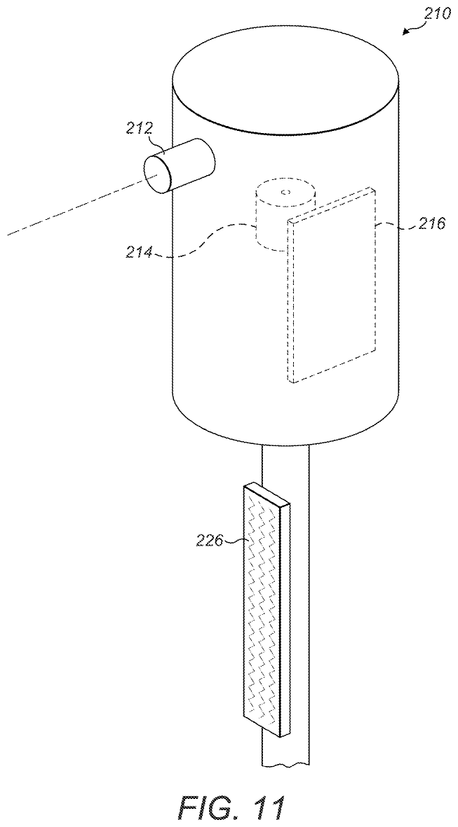

The scanner or scanner unit 210, shown in FIG. 11, is capable of being placed securely at a desired location, where it stands stably, e.g. likewise on a tripod 211. It includes a directional beam generator, usually a laser 212, which can be controlled and moved, or the entire scanner is turned, by an actuator 214 such as a stepper motor to point in any desired direction, possibly about a complete 360° turn, but preferably at least 180° and typically up to about 270-290°. It also contains a distance-measuring device or function, similar to that used in standard surveyor's measures, giving a distance reading of any object that the beam strikes. A separate measurer could however be used. The scan range is preferably at least 20 m, often up to 50 m, 100 m or even more.

The scanner, like the ADDR, contains a rechargeable battery, so it is self-contained, and should be able to carry out a number of surveys on a single charge; for instance, at least six and preferably ten such surveys might represent a day's work, allowing time for a recharge overnight.

The scanner further contains an interface so that it can be controlled remotely, in particular by an operator (not shown), using the tablet computer 102, for instance, connected by Wi-Fi if present, or Bluetooth, or any suitable means of communication. The smart scanner could create a Wi-Fi access point, for instance, but usually this will be in the ADDR. The necessary calculations for the positioning are carried out by a processor on a circuit board 216 in the scanning unit, though this may also be done remotely, at least in part, for instance in the operator's tablet.

The scanner may repeatedly poll for progress via a network of APIs, or alternatively it may make use of MQTT socket technology to make the processing a direct communication process.

The scanner can scan objects in the observable arc, with a range typically of up to 100 m, though with the use of a suitable sensor it could be more. Through filtering algorithms, it is then able to identify key features (reflector boards in the present case) to calculate the position, and in most cases also the angular orientation, of the objects; these can then be used as reference points.

Furthermore, to remove the need for a skilled surveyor, the scanner is designed to generate a number of audio and visual cues that guide the user to achieve the task of setting up the fixed points of reference (reflectors). The overall setup time for a fixed-point localisation system can be reduced from hours to minutes through this invention.

The smart scanner can analyse the use case and dynamically change the position that the fixed reference points should be placed. It is then able to guide the user to place these references (reflectors) dynamically on a case-by-case basis. This is done by means of the tablet computer 102 discussed below.

The passive reflectors 220 to be positioned each having a passive reflecting board 222; a typical size of the reflectors would be 50 cm width (say 20-100 cm in most cases) and 30 cm height (10-50 cm). These are to be placed around the periphery of the area 120 with the board approximately facing the centre of the area. The reflectors 220 will here be used as position references for a subsequent ground-printing process, but many other applications are possible. The reflecting surfaces are made of highly reflecting material, most simply just a smooth white board, the requirements being that the operator can see where the laser hits the board and the scanner can detect a reflection at various angles (since the board will often not be facing the scanner). Selection of the board surface could be optimised by analysing the correlation between backscattering intensity of the laser (perhaps pulsed) and the spectral reflectance at the wavelength of the laser deployed.

The area is usually a planar or near-planar surface, and ideally flat and level—certainly if it is an indoor area or a sports field, though the system can cope with some deviation from level, for instance if the tripods are adjustable. Also, almost all professional sports pitches are formed to be slightly convex, to aid runoff drainage. Adjustability when positioning in such instances is advantageous. The reflecting boards 222 and the scanner, or its laser, will in a typical example be at about head height, say about 1.5-2 m, while the retroreflectors 226 will have their midpoint at the level of the ADDR, which might be about 0.8 m.

A typical procedure for setting up the reflectors 220 in preparation for a subsequent print is as follows.
1. The operator uses the tablet interface 102 to instruct the “smart” scanner 210 to start the survey process, by selecting or confirming inputs for the number of target objects to be placed, the scan distance for each of the target objects, and other important positional references.
2. The scanner signals the start of the process to the user through audio and/or visual cues.
3. The scanner homes the laser rotation (i.e. sets the orientation of the x axis), if necessary.
4. The scanner moves to the angle corresponding to the position of the first or next target object or reflector and begins measuring the distance to the expected line-of-sight surface; meanwhile the operator takes the reflector and moves it to intercept the laser beam.
5. The scanner waits until the operator crosses the laser beam; once such an interception is detected it starts to signal any necessary adjustment of the distance from the laser; to this end the scanner emits audio indicators from a buzzer that increase in frequency the closer the measured distance is to the target distance (a hot-cold methodology).
6. The scanner confirms a correct distance reading ten times and then allows the operator some time to set up the reflector, indicated by increasing frequency tones from the buzzer.
7. The scanner makes a final measurement to check that the distance is correct.
8. If the distance is correct, the scanner process continues to step 9; otherwise it loops back to step 5.
9. If there are still target objects or reflectors to be set, the scanner loops back to step 4.
10. Once all reflectors 220 have been placed by the operator and turned to face toward the middle of the area of interest, being therefore within the required placement constraints, the scanner homes the laser rotation.
11. An audio signal informs the operator that the survey is about to begin.
12. Survey scanning then begins. The scanner directs itself towards each of the boards 222 in turn and measures the distance to a number of points across the surface of the reflector.
13. Survey time is reduced by only scanning the known arc area around the reflectors. One such hunting algorithm limits scanning to a 5-degree arc from the assumed centre point of the reflector, though other methods are possible depending on target object/reflector dimensional characteristics, such as inclusion of a camera within the scanner and deployment of image recognition to find the target, edge and feature detection, or object recognition for example, by comparing known images to images identified by the scanner's camera.
14. The scanner computes the survey at the end when it has collected all the measurements. In this way the position and orientation of each target object or reflector is accurately measured, and can be defined in dimensional terms (distance from scanner, length, angular orientation), and reference to a global coordinate system, for example.
15. The result, essentially a map of the layout of the target objects or reflectors, is automatically passed to the operator interface and transferred to the ADDR (e.g. printer), for instance via a router or the Cloud. The entire operation typically takes less than three minutes, in contrast to a manual process which might take hours and require specialist tools.

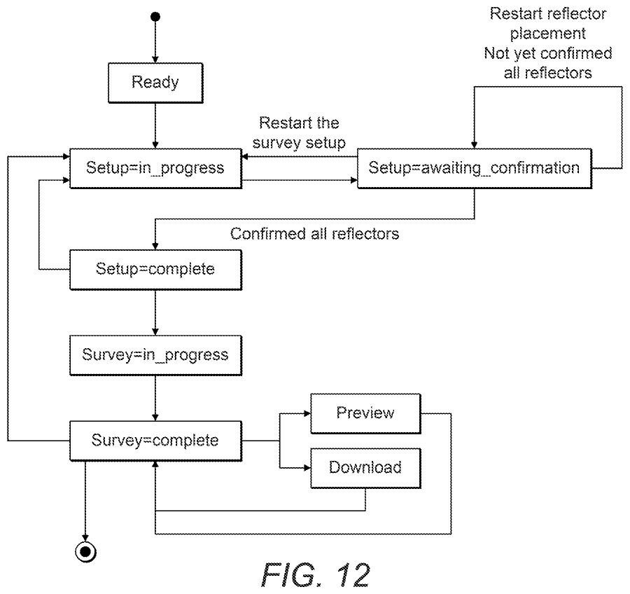

These steps are shown in outline in FIG. 12, showing the states of the smart scanner as it proceeds through the prescribed steps, essentially autonomously apart from the fact that the physical approximate placement of the reflectors has to be done by the operator. Even this is not necessary if the survey takes place in a site with existing, fixed, target objects or reflectors and the survey indicates that they are (still) correctly positioned and aligned, as per stored reference scan data which the system compares in a ‘lookup’.

The ADDR 10 can preferably create a Wi-Fi access point which the scanner can communicate directly through without any external networking infrastructure. The robot is used to host the operator interface server that communicates directly with the scanner webserver. It should therefore be present during the setup process, even though it is not needed for printing until after that process is finished. Alternatively the network can be hosted elsewhere in the system or even in a separate component.

The purpose of the wireless transfer is to automate transfer between the smart scanner/reflector 210 and the robot 10. Another purpose of the wireless transfer channel is to communicate real-time consumption data of deposition materials to a monitoring cloud database, which uses the data for forecasting demand, forecasting refill rates, forecasting automated refilling schedule intervals, remote robot or complete system performance diagnostics using ‘over the air’ methods. Eliminating the need for the operator to act removes the possibility for human error.

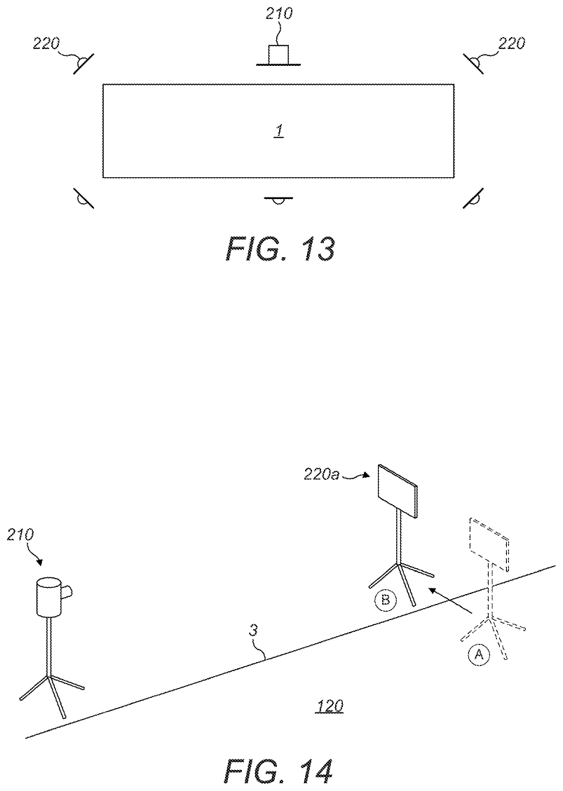

Typically the scanner itself has a reflector and is then itself used as a passive reflector for subsequent orientation, positioning or navigating operations. Normal triangulation or trilateration requires a minimum of three reflectors (including the “smart reflector”), but four or more can be used to suit the landscape. For instance, FIG. 13 shows a total of six reflectors surrounding a long rectangular field.

In one mapping application for which the present setup system is useful, automated deposition or printing is required on the surface of a sports pitch 120. This print must therefore usually align with a feature of the pitch, such as a touchline. In this case, step 3 involves aligning the “home” or zero of the laser rotation to be parallel with the touchline. This is also done by the operator placing a tripod 220 with its reflector 222 so that the laser is parallel, as shown in FIG. 14. The operator is guided to place a reflector that will make up a line between the smart reflector and passive reflector allowing the operator to align it to another line (i.e. the pitch line or a landmark).

The process starts by placing the smart scanner roughly where print is required. After choosing which axis of the print (X or Y) to use for alignment in the operator interface the smart scanner starts to point to an initial position (position A). Once this is done, the operator is then required to move the scanner to the correct distance confirmed by the reflection from the passive reflector 222.

Once the scanner 210 is at the correct distance the laser remains active and the operator moves the passive reflector (i.e. from position 1 to position 2) to align the print with the pitch line until a point when they are satisfied. Now the smart reflector can carry out the rest of the guided setup and automated survey.

The “smart scanner” thus provides a set of processes that automate the complicated steps, taking responsibility away from the operator for otherwise complicated manual operations. For example, if the operator needs to set up an area of X by Y metres, he only needs to choose the location and orientation of the print, as the smart scanner guides the rest of the steps, completes the measurements and returns the computed results.

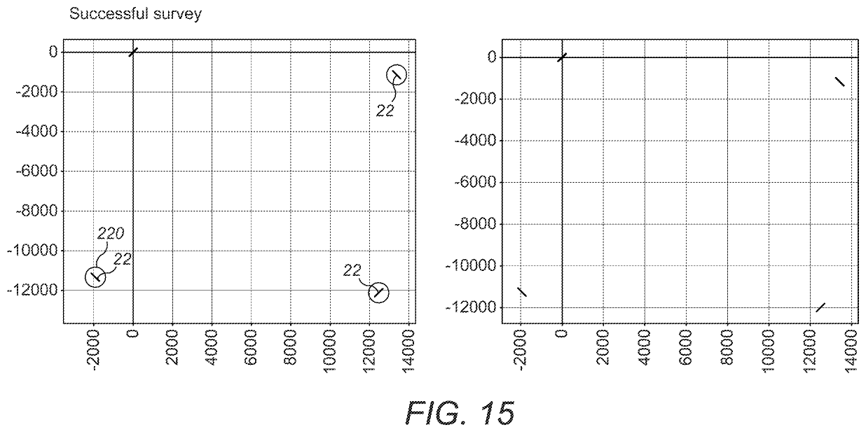

Once the operator has placed all the passive reflectors and the scanner has confirmed that they are all within the tolerance limits in terms of distance and orientation, the survey procedure starts (or this may be initiated by the operator). This procedure is illustrated in FIG. 15, which shows a notional map held in the memory of the system. Here the scanner is at (0, 0) and the tripods 220 with their retroreflectors 226 are intended to be around the periphery of the area of interest. After the placement of the passive reflector tripods 220, the boards 222 are supposed to be at certain locations, assuming the operator has been following the guidance and the reflectors were not subsequently disturbed. A notional margin of error 220 is shown, which is a tolerance or range of angles (say 1-5°, typically about 2.5°) and distances (say 0.1, 0.2 or 0.5 m) within which the reflectors are expected to be found. The scanner scans these areas and detects reflections giving rise to lines corresponding to the boards 222. If all these lines are within the tolerances the survey is successful, as shown in the Figure. If any of the lines are outside, the survey fails and at least one repositioning has to be carried out by the operator.

These results essentially form a map of the terrain, to be used by the ADDR. The robot will require a precise location to carry out its deposition activity (for example to print by laying pixels on the ground). Its only reference for navigation is the set of reflectors, though GPS or other positional methods can be used in addition. Therefore, the setup inherently affects the print quality.

It is desirable to achieve an accuracy of distance measurement equivalent to the size of a blade of grass, say +3 mm, and preferably +1 mm. Such accuracy can be achieved by commercially available laser measuring sensors.

Furthermore, the data collection can be carried out during one sweep by using a “zone hunting” algorithm. By reserving slower scanning for use over small target zones (area 220 above), as opposed to continuous LIDAR measuring over the entire sweep, the operating time and measurement error can be reduced. Depending on hardware and gearing options, it is possible to achieve high angular accuracies, of +0.25 degree, +0.10, +0.05 or even +0.01 degree, particularly if the scanner dynamically selects how many times the reflector is scanned by deploying machine learning or deep learning algorithms; for instance, scanning a reflector of a given width becomes increasingly challenging as the distance from the scanner increases and the arc of the reflector decreases.

The stepping motor rotating the laser should allow a single step that determines its arc to be as low as possible. In the present embodiment the minimum achievable arc step is 0.01°, which at 50 m, say, represents a distance of about 10 mm, but clearly this can vary with different stepper motors.

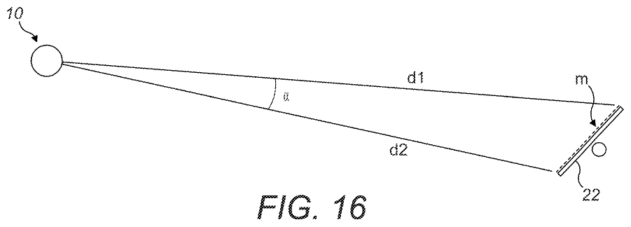

An algorithm is used that determines the number of points the laser has to project onto a reflector to get enough data to compute its position and orientation. The scanner contains in memory the ideal positions of the passive reflector boards 222. It scans within a suitable narrow range, say 2.5° or 5°, of each of these positions in turn, depending on distance and reflector dimensions. The angular scan interval can be pre-set, but preferably it is adjusted by an algorithm in dependence on the expected distance of each reflector. Assuming the board is approximately in the right position to start with, a set of measured points will result, most corresponding to genuine reflections but some spurious or inaccurate, due for instance to noise. Such inaccuracies can result from vibrations of the reflector panel, for example caused by wind disturbance, especially when the survey is conducted outdoors. A typical set of points is shown schematically as “m” in FIG. 16.

Noise-cancelling and filtering can then be used to determine a reliable line of points which thus represents an accurate location in 2D space of the reflector. Distance measurements d1, d2 to the outer edges of the reflector give its orientation calculated by the cosine rule, as again apparent from FIG. 16.

Once the line is determined, its normal is taken; the line of this normal should have been set up by the operator to point approximately in the direction of the centre of the area of interest, e.g. the image to be printed in a printing case, so that the robot has the best line of sight to the reflecting strip.

Once the location of one reflector has been accurately determined, the scanner moves on rapidly—for instance in angular steps of 1-10°—to the next reflector, until all have been surveyed; preferably the angular steps are determined autonomously from learned prior scans related to a reflector of a known size. The same is true if the reflectors are mounted on existing, fixed parts, such as parts of a stadium fence or the inside (or outside) of a warehouse. The set of data is then stored by the scanner 210 and also sent to the ADDR 10, and simultaneously copied to the cloud to create a permanent reference for future machine-learning applications (for example where an ADDR is required to operate in an identical environmental configuration).

In a refinement, during a survey the scanner or smart reflector takes account of the known distance of the passive reflector to adjust the angular resolution of its rotation, up to the limit of 0.01° in the present example. For instance, it can be ensured that the number of points measured across a reflector board is about the same regardless of distance. This enables operation at maximum accuracy without slowing the process down for reflectors at different positional distances away from the scanner, which would, in the case of nearer reflectors, otherwise accumulate an excess number of points.

The setup requires a minimum of three, preferably at least four, reflectors for a deposition, e.g. print, at least for a rectangular area, but, as noted with reference to FIG. 13, more can be used.

Theoretically the smart reflector can guide the user to place as many fixed reference points as required and can scan a full 360 degrees to identify these references. In a typical case these references are a 50 cm wide rectangular plate, for wider applications these reference points can take any 2D form conceivable that can be scanned from a single viewpoint (i.e. the smart scanner/reflector).

While examples have been described with reference to sports fields, tracks or buildings, where the ground or floor would obviously be planar or flat, the system would work on ground that was not level, provided that it was continuous and not excessively steep, and provided that smart reflector scanner has line of sight with target objects or reflectors. Here the tripods could incorporate adjustment so that they could be made vertical and/or parallel in any location, using additional indicating means to determine parallelism or verticality between reflectors using sensors or levels.

The robot could operate as a single system, or it could operate within a distributed network which comprises one or many ADDR's (deposition robots) that may be working on a ‘mission’ together as a collective digitally joined ‘fleet’ (to cover the ground faster, or complete large area installations), or individually (but in different locations on different missions), yet still all centrally controlled, in each case requiring reference and navigation points provided by reflectors, hence the significant advantages arising from automating the placement of objects or reflectors.

In theory the kit could work without a cloud SAAS management platform, though that would require all the intelligence to be contained in the user interface tablet.

Wider applications of this concept and technology could be as follows:

Any application that requires accurate placement of markers/emblems/pixels in a location, possibly in or around a field for farming, or indoor applications such as a warehouse.

Any application that requires accurate surveying of 2D feature profiles.

Any application that has a need for points of reference to be placed out for the navigation system of a device.

Navigation examples where GPS is not available or does not provide the localisation accuracy required for the application.

The surveying algorithm on its own can be applied to applications that require surveying to be carried out in a focused and efficient manner, especially by non-skilled operators, such as building-site surveys.

Any application where markers must be placed relative to landmarks in the environment.

Any application that requires a virtual co-ordinate grid be applied to an environment for use with navigation or localisation systems.

1. A kit of parts for autonomously depositing materials in a desired pattern on or in the ground within a defined zone, comprising:
at least one Autonomous Distributed Deposition Robot (ADDR, 10) with at least one container for material to be deposited;
a smart scanner (210) including a laser scannable over the zone, to assist in the automated setup of the zone;
at least two passive reflectors (220) for reflecting the beam from the laser during setup, and for later use by the ADDR for navigation;
an operator interface (102) for control and/or reception of information from the ADDR and/or scanner and/or the Cloud;
a network access point (22) enabling the components to communicate with each other; and
software enabling the components to communicate and to enable the robot to carry out the deposition.

2. (canceled)

3. A kit according to claim 1, in which the software includes instructions about where the operator is to set up the passive reflectors (220), and instructions for carrying out a deposition operation upon an instruction from the operator.

4. A kit as claimed in claim 1, wherein the robot comprises an on-board control system (22) for controlling the movement of the ADDR and the deposition, and including a communications link for communication with the operator interface, optionally wherein the robot further comprises a laser (40) steerable to hit the passive reflectors and so accurately ascertain the position of the robot.

5. (canceled)

6. A kit according to claim 1, wherein the robot includes one or more deposition heads/systems/pumps, and further including a purge tank for catching purged deposition materials cleaned from the deposition heads/systems/pumps prior to use and at the end of use as a cleaning cycle; and/or a water (or other cleaning material) tank for cleaning the at least one deposition material container and associated ADDR pipes with water or other cleaning material.

7. A kit according to claim 1, further including a charging and data-sync station, and/or an autonomous deposition material filling station (6).

8. (canceled)

9. (canceled)

10. A kit according to claim 1, wherein the ADDR comprises a material deposition container containing a flexible bag (32) containing a material for deposition, the flexible bag being provided with an airtight valve outlet (34) sealed to the flexible bag, optionally wherein the flexible bag containing a material for deposition is housed within a substantially rigid primary packaging (14-18).

11. (canceled)

12. A kit as claimed in claim 10, wherein the valve outlet is a one-way valve open during deposition of material and a hose (36) is attached to the valve outlet at one end and at the other end of the hose to a nozzle (42) in a travelling printhead (60), optionally wherein the hose (36) is further attached to a manifold (44) connected to a tank (46), wherein the tank contains a solvent, nozzle flush material or luminescent nanoparticles.

13. (canceled)

14. A kit as claimed in claim 12, wherein the hose is attached to a pump (35) for expressing the material through the nozzle.

15. A kit as claimed in claim 12, wherein, when the robot is in use and depositing material on the ground, the on-board control system is configured to periodically gather weight data from a weight-monitoring device associated with the bag, and optionally to transmit the data to a remote resource, such as a cloud server, or an edge device optionally a tablet or smartphone.

16. A kit as claimed in claim 1, wherein the robot (10) comprises a chassis on a ground wheel arrangement (24) with a nozzle array (42) on a traverse guide, the traverse guide permitting movement of the nozzle array beyond the width of the ground wheel arrangement, the traverse guide being either fixed in relation to the ground wheel arrangement or movable relative to the ground wheel arrangement in the direction of travel, so that an area of ground can be deposited with material in or under the ground while the ground wheel arrangement is stationary.

17. A kit as claimed in claim 10, wherein the flexible bag is supported upon a wedge (130) tapered to provide a downward slope towards the airtight valve outlet, or a wedge (130a) is provided in two corners of a primary packaging containing the flexible bag, or both.

18. (canceled)

19. A kit as claimed in claim 1, wherein the robot (10) is configured with a nozzle array (42) to print an image or logo on a surface, the robot housing two or more flexible bags (32) containing a material for deposition, the material for deposition contained within each flexible bag being an ink or paint selected from a cyan, magenta, yellow, black, white green, blue or red colour, the image or logo optionally being an advertising logo, design or safety warning.

20. A kit as claimed in claim 1, wherein the scanner (210) for use in placing the reflectors (220) at planned locations over/around an area of ground, comprising: a memory for storing the planned locations of the objects; a means (212) for generating and directing a beam over the area in various controllable directions corresponding to the planned locations; a means for measuring distance in various directions; and a signalling means for indicating to an operator whether an object in the path of the beam is at the relevant planned location, optionally wherein the means for generating and directing the beam is a laser device (212) and it includes the distance-measuring means.

21. (canceled)

22. A kit according to claim 20, in which the signalling means emits a visual or an audible signal, or both.

23. A kit according to claim 20, any of claims 20 to 22, wherein the scanner further includes a processor and a memory configured to calculate from each distance measurement how near the object is to its prescribed distance and to indicate accordingly to the signalling means the signal to be given to the operator.

24. A kit according to claim 23, in which the processor is configured, after the objects have been placed, to direct the beam and distance-measuring means to survey the objects and to generate precise measurements of their position and, optionally, orientation.

25. A kit according to claim 20, in which the passive reflectors (220) consist of reflecting areas (226) mounted on stands (220), the scanner also including such a reflecting area.

26. A kit according to claim 20, in which the scanner (210) includes a memory for storing expected locations of the objects; a means (212) for generating and directing a beam over the area in various controllable directions; a means for measuring distance to an object detected in such a direction; and a processor for calculating whether a given set of reflections corresponds to a known or expected object.

27. (canceled)

28. A kit according to claim 26, in which the memory stores data about how near the object is, the data being usable to indicate accordingly to the processor whether the received signal is likely to correspond to the object sought.

29. A method of deploying a kit according to claim 1, in which the ADDR is driven to a point in or near the zone, the smart scanner (210) is placed at a suitable point according to instructions issued by the operator interface (102), the passive reflectors are placed around the zone according to indications by the smart scanner (210), the smart scanner confirms the positioning of the passive reflectors as necessary, and the ADDR (10) is the operated to travel over the deposition zone depositing material according to a scheme stored in memory, and orienting itself by means of the scanner and reflectors.
